(19) United States
(12) Patent Application Publication
(10) Pub. No.: US 2012/0168412 A1
(43) Pub. Date: Jul. 5, 2012

(54) APPARATUS AND METHOD FOR FORMING AN APERTURE IN A SUBSTRATE

(75) Inventor: Andy HOOPER, Portland, OR (US)

(73) Assignee: ELECTRO SCIENTIFIC INDUSTRIES, INC, Portland, OR (US)

(21) Appl. No.: 13/343,640

(22) Filed: Jan. 4, 2012

Related U.S. Application Data
(60) Provisional application No. 61/430,045, filed on Jan. 5, 2011.

(51) Int. Cl. B23K 26/36

(52) U.S. Cl. 219/121.69; 219/121.68

(57) ABSTRACT

A method of forming an aperture in a substrate having a first side and a second side opposite the first side includes irradiating the substrate with a laser beam to form a laser-machined feature within the substrate and having a sidewall. The sidewall is etched with an etchant to change at least one characteristic of the laser-machined feature. The etching can include introducing the etchant into the laser-machined feature from the first side and the second side of the substrate. An apparatus and system for forming an aperture are also disclosed.

### CROSS REFERENCE TO RELATED APPLICATIONS

This application claims the benefit of U.S. Provisional Application No. 61/430,045, filed Jan. 5, 2011.

### BACKGROUND

Embodiments of the present invention as exemplarily described herein relate generally to apparatuses and methods for forming apertures in substrates. More particularly, embodiments of the present invention relate to apparatuses and methods capable of efficiently forming apertures by processing laser-machined features.

It is generally known that many semiconductor manufacturing applications require the use of “through-silicon vias.” Typically, a through-silicon via or (TSV) is a vertical channel extending through a silicon substrate, which can be coated or filled with a conductive material to allow electrical current or heat to flow from one side of the substrate to the other. TSVs can be formed by various methods. For example, TSVs can be formed in a dry etch process in which reactive gases etch the substrate under vacuum. However dry etch processes can produce TSVs with sidewalls having an undesirably scalloped surface profile. To avoid the scalloped surface profile, the dry etch process is typically slowed significantly or the TSV is subjected to additional processing (e.g., coating and etching processes). TSVs can also be formed using lasers in which a laser beam heats and ablates the substrate. However, laser drilling typically produces TSVs having sidewalls with non-uniform composition and crystalline structure, and an undesirably rough surface profile. A number of processes, which include dry etching processes and wet etching processes, have been proposed to address the deleterious effects caused by laser drilling. Such processes have limited benefit, however, because they do not produce TSVs with many desirable characteristics (e.g., adequately smooth sidewalls and controllable aspect ratio, taper, entrance diameter, exit diameter and cross-sectional profile).

### SUMMARY

In one embodiment, a method of forming an aperture within a substrate includes providing the substrate having a first side and a second side opposite the first side; irradiating the substrate with a laser beam to form a laser-machined feature within the substrate, the laser-machined feature having a sidewall; and etching the sidewall with an etchant to change at least one characteristic of the laser-machined feature, wherein the etching comprises introducing the etchant into the laser-machined feature from the first side and the second side of the substrate.

In another embodiment, a system for forming an aperture within a substrate having a first side and a second side includes a laser configured to irradiate the substrate with a laser beam to form a laser-machined feature within the substrate; and an etch processing system having an etch chamber configured to receive the substrate, the etch processing system configured to introduce an etchant into the laser-machined feature from the first side and the second side to the substrate, the etchant configured to remove at least a portion substrate adjacent to the laser-machined feature.

### BRIEF DESCRIPTION OF THE FIGURES

FIG. 1 is a cross-sectional view schematically illustrating a substrate according to one embodiment.

FIG. 2 is a cross-sectional view schematically illustrating one embodiment of a method of forming a laser-machined feature in the substrate shown in FIG. 1.

FIG. 3 is a cross-sectional view schematically illustrating one embodiment of a method of processing the laser-machined feature shown in FIG. 2 to form an aperture.

FIGS. 4 to 8 are cross-sectional views schematically illustrating apertures that may be formed according to some embodiments.

FIG. 9 schematically illustrates one embodiment of an apparatus configured to form an aperture in a substrate.

### DETAILED DESCRIPTION OF THE ILLUSTRATED EMBODIMENTS

The invention is described more fully hereinafter with reference to the accompanying drawings, in which example embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that, although the terms first, second, third, etc., may be used herein to describe various elements, components, regions, sets, ends, paths, etc., these elements, components, regions, sets, should not be limited by these terms. These terms are only used to distinguish one element, component, region, set, end, path, etc., from another element, component, region, set, end, path, etc. Thus, a first element, component, region, set, end, path, etc., discussed below could be termed a second element, component, region, set, end, path, etc., without departing from the teachings provided herein.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, ends, paths, and/or groups thereof.

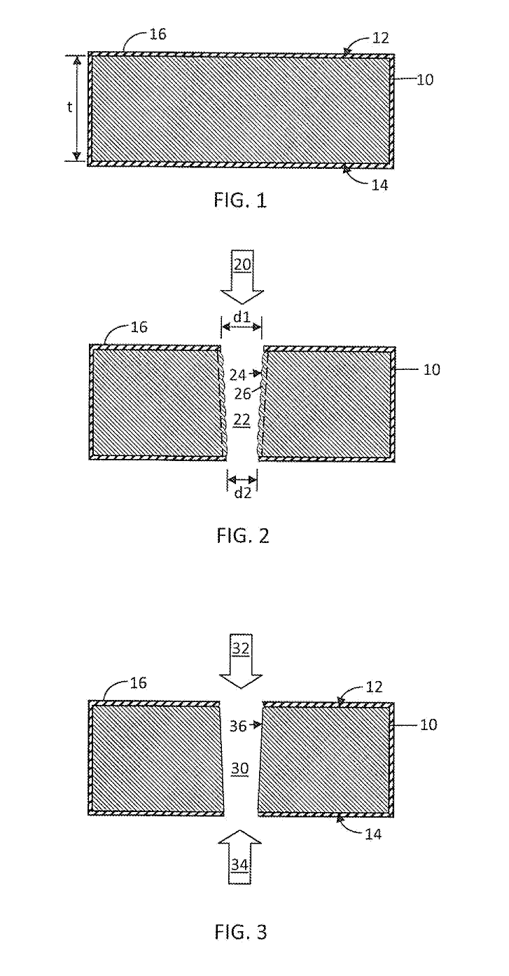

FIG. 1 is a cross-sectional view schematically illustrating a substrate according to one embodiment.

Referring to FIG. 1, a substrate 10 having an upper side (also referred to as a “first side”) 12 and a lower side (also referred to as a “second side”) 14 may be provided. The substrate 10 can be formed of a material such as silicon. In one embodiment, the substrate 10 is provided as a doped or undoped silicon substrate (e.g., a monocrystalline silicon substrate, a polycrystalline silicon substrate, or the like). In one embodiment, the substrate 10 is provided as an interposer substrate. As is known in the art, interposer substrates enable communication (e.g., electrical, optical, or the like, or a combination thereof) between two devices or chips (e.g., in an electronic package). In other embodiments, however, the substrate 10 may be provided as a substrate, a semiconductor die, a workpiece, or the like. In still other embodiments, the substrate 10 can be formed of one or more materials such as glass, sapphire, SiC, GaN, GaAs, InP, and the like. A thickness, t, of the substrate 10 between the first side 12 and the second side 14 may be in a range from about 15 to about 1500 μm. In the illustrated embodiment, the first and second sides 12 and 14 are bare (i.e., components such as devices, conductive lines, and the like, are absent from each side). In other embodiments, one or more components (e.g., devices, conductive lines, and the like) may be formed on the first side 12, the second side 14 or a combination thereof.

In the illustrated embodiment, an etchmask layer 16 is formed on the first side 12, on the second side 14 and on edge sides extending between the first and second sides 12 and 14. The etchmask layer 16 is formed to allow the substrate 10 to be etched at selected locations during a subsequent etch process, which will be discussed in greater detail below. In one embodiment, the etchmask layer 16 is formed from a material that can be etched at a slower rate during the subsequent etch process than the substrate 10, or that will not be etched at all. For example, the etchmask layer 16 may be formed of a nitride material (e.g., silicon nitride, boron nitride, silicon oxynitride, etc.), an oxide material (e.g., silicon oxide, etc.), a region of the substrate 10 containing dopant material (e.g., P, As, Sb, B, Ga, In, Al, etc.), a polymer material (e.g., photoresist, polyvinyl alcohol, lacquer, varnish, wax, glue, ink, dye, pigment, tape, poly(methyl methacrylate), polystyrene, surfactants, etc.), or the like or any combination thereof, by any suitable process. In other embodiments, however, the etchmask layer 16 may be omitted.

FIG. 2 is a cross-sectional view schematically illustrating one embodiment of a method of forming a laser-machined feature in the substrate shown in FIG. 1.

Referring to FIG. 2, the substrate 10 is irradiated with a laser beam 20 during a laser-drilling process (e.g., a trepan laser-drilling process, a percussion laser-drilling process, or the like or a combination thereof) to form a laser-machined feature 22. As exemplarily illustrated, the laser-machined feature 22 is a through via. It will be appreciated, however, that the laser-machined feature 22 could also be provided as an alignment feature, or the like. In illustrated embodiment, the laser-drilling process is performed such that the portion of the etchmask layer 16 on the first side 12 of substrate 10, the substrate 10 and the portion of etchmask layer 16 on the second side 14 of substrate 10 are sequentially irradiated with the laser beam 20 to form the laser-machined feature 22. In one embodiment, the laser-drilling process may employ the use of one or more assist gases (e.g., oxygen, nitrogen, or the like or a combination thereof) and/or water to enhance material removal of the substrate 10 during the laser-drilling process and/or to cool the substrate 10 during the laser-drilling process.

Generally, characteristics of the laser-machined feature 22 such as aspect ratio, entrance diameter (i.e., diameter d1 of the laser-machined feature 22 at a location adjacent to the first side 12), exit diameter (i.e., diameter d2 of the laser-machined feature 22 at a location adjacent to the second side 12), taper (i.e., ratio of the exit diameter to the entrance diameter), aspect ratio (i.e., ratio of the feature length to the feature width) and cross-sectional profile can be influenced by adjusting one or more parameters of the laser-drilling process. Examples of parameters of the laser-drilling process that can be adjusted include, for example, focal plane location, laser pulse energy, laser pulse duration, laser pulse temporal profile, laser pulse repetition rate, number of laser pulses, laser spot size, wavelength, and the like. The entrance diameter d1 and the exit diameter d2 can be in a range from about 1 μm to about 500 μm. In the illustrated embodiment, the exit diameter d2 is less than the entrance diameter d1. In another embodiment, however, the exit diameter d2 can be equal to the entrance diameter d1. Accordingly, the cross-sectional profile of the laser-machined feature 22 can be tapered (as illustrated) or vertical. Generally, the aspect ratio of the laser-machined feature 22 is in a range between about 1:1 to about 50:1. For example, the aspect ratio of the laser-machined feature 22 can be in a range between 2:1 to 50:1. In one embodiment, the aspect ratio of the laser-machined feature 22 is about 20:1.

During the laser-drilling process, material (e.g., of the substrate 10 and the etchmask layer 16) irradiated by the laser beam 20 is ejected from its original location in gaseous, liquid and possibly solid form. As the laser-drilling process progresses through the substrate 10, the ejected material can cool and stick to surfaces that have been previously formed by the laser-drilling process. As a result, sidewalls 24 of the laser-machined feature 22 can be undesirably rough. Also during the laser-drilling process, portions of the substrate 10 adjacent to regions irradiated by the laser beam 20 can become heated, creating “heat affected zone” or (HAZ) 26 formed of reflowed substrate material, amorphous substrate material, polycrystalline substrate material, recrystallized substrate material, and the like. The HAZ 26 of substrate 10 may also include high-stress regions, cracks, and other thermally-induced features. Accordingly, the HAZ 26 may extend from the sidewalls 24 of the laser-machined feature 22 some distance into the substrate 10. When the substrate 10 is formed of silicon material, the HAZ 26 may be formed of silicate material, melted silicon, reflowed silicon, recast silicon, recrystallized silicon, polycrystalline silicon, amorphous silicon, or the like or a combination thereof.

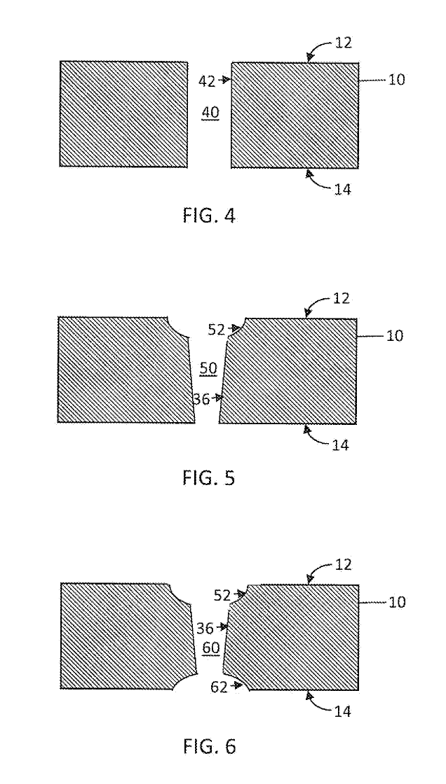

FIG. 3 is a cross-sectional view schematically illustrating one embodiment of a method of processing the laser-machined feature shown in FIG. 2 to form an aperture. FIGS. 4 to 8 are cross-sectional views schematically illustrating apertures that may be formed according to some embodiments.

Referring to FIG. 3, after forming the laser-machined feature 22, the sidewalls 24 can be etched during an etching process such that the HAZ 26 is at least partially removed to form an aperture such as aperture 30. In another embodiment, however, the HAZ 26 can be completely removed during the etching process. As will be discussed in greater detail below, one or more characteristics of the laser-machined feature 22 (e.g., the surface roughness of sidewalls 24, the entrance diameter d1, the exit diameter d2, the taper, the aspect ratio, the cross-sectional profile, etc.) can be changed during the etching process to produce the aperture 30.

The etching process includes a plurality of etch processes (e.g., including one or more dry-etch processes, one or more wet-etch processes, or a combination thereof) in which an etchant is used to etch sidewalls 24 of the laser-machined feature 22. In one embodiment, sidewalls 24 of the laser-machined feature 22 are etched using a first etch process and a second etch process. In the first etch process, an etchant is introduced into the laser-machined feature 22 from the first side 12 of the substrate 10. In the second etch process, an etchant is introduced into the laser-machined feature 22 from the second side 14 of the substrate 10. The etchant used in the first and second etch processes can include a dry etchant (e.g., an etchant gas), a wet etchant (e.g., an etchant solution), or a combination thereof. The etchant used in the first etch process can be the same or different from the etchant used in the second etch process.

In one embodiment, the first etch process can be performed before, during or after the second etch process. Accordingly, a dry etchant can be introduced into the laser-machined feature 22 from the first side 12 before, while, or after a dry etchant is introduced into the laser-machined feature 22 from the second side 14. In one embodiment, a dry etchant can be introduced into the laser-machined feature 22 from the one of the first side 12 and the second side 14 either continuously or intermittently while a dry etchant is introduced into the laser-machined feature 22 from the other of the first side 12 and second side 14.

In the illustrated embodiment, the first etch process is performed by introducing a dry etchant into the laser-machined feature 22 from the first side 12 along the direction indicated by arrow 32, and the second etch process is performed by introducing a dry etchant into the laser-machined feature 22 from the first side 12 along the direction indicated by arrow 34. It will be appreciated, however, that the first and second etch processes can be performed by introducing a dry etchant into the laser-machined feature 22 from the first and second sides 12 and 14, respectively, but along the same direction. For example, after performing the first etch process in which dry etchant is introduced into the laser-machined feature 22 from the first side 12 along the direction indicated by arrow 32, the substrate 10 can be moved (e.g., reoriented) in any suitable manner such that the positions of the first side 12 and the second side 14 illustrated in FIG. 3 are flipped or reversed. After being flipped, the second etch process can be performed to introduced dry etchant into the laser-machined feature 22 from the second side 14 along the direction indicated by arrow 32.

The etch rate and effects of the first and second etch processes on the laser-machined feature 22, and thus the characteristics of the aperture produced, can be influenced by adjusting one or more parameters of one or both of the first and second etch processes employed. Parameters of the first and second etch processes (also referred to herein as “dry-etch parameters”) that can be adjusted include, for example, the composition of the dry etchant, the flow rate of the dry etchant within the laser-machined feature 22, the temperature of the dry etchant, duration of the first and/or second etch process, the distance between the substrate 10 and an etchant source (e.g., an etchant gas showerhead, an etchant solution nozzle, etc.) during the first and/or second etch process, or the like, or a combination thereof.

The dry etchant used in the first and second etch processes can contain, for example, a fluorocarbon, oxygen, chlorine, a boron tetrachloride compound, or the like or a combination thereof. In one embodiment, the dry etchant includes an etchant gas such as xenon difluoride (XeF₂). Optionally, a carrier gas (e.g., helium, argon, nitrogen, or the like or a combination thereof) can be used to entrain to help deliver the dry etchant into the laser-machined feature 22.

After performing the first and second etching processes, the etchmask layer 16 may be removed from the substrate 10. In one embodiment, an optional pre-clean process may be performed before the etching process to remove debris found within the laser-machined feature 22 formed during the laser-drilling process.

By etching the sidewalls 24 of the laser-machined feature 22 as described above, one or more characteristics of the laser-machined feature 22 (e.g., the surface roughness of sidewalls 24, the entrance diameter d1, the exit diameter d2, the taper, the aspect ratio, the cross-sectional profile, etc.) can be changed to form an aperture having one or more desired characteristics. One or more dry-etch parameters can be selected to influence one or more characteristics (e.g., taper, entrance diameter, exit diameter, cross-sectional profile, aspect ratio, surface roughness, etc.) of the aperture produced by the etching process. It will be appreciated that the characteristics of the laser-machined feature 22 can also affect how the dry-etch parameters influence one or more characteristics of the aperture produced by the etching process. Thus, the parameters of the laser-drilling process can be selected to influence one or more characteristics of the aperture produced by the etching process.

In one example, one or more dry-etch parameters can be selected to influence the entrance diameter, exit diameter and/or surface roughness of the aperture without significantly influencing the cross-sectional profile of the aperture. As a result the entrance diameter, exit diameter and surface roughness of the laser-machined feature 22 can be changed to produce an aperture such as aperture 30 having a desired entrance diameter, exit diameter and/or surface roughness, but the cross-sectional profile of the laser-machined feature 22 can be preserved in the aperture 30. As used herein, the cross-sectional profile of the laser-machined feature 22 is preserved in the aperture if both the laser-machined feature 22 and the aperture have the same type of cross-sectional profile. When the cross-sectional profile of the aperture is not of the same type as that of the laser-machined feature 22, the cross-sectional profile of the laser-machined feature 22 is not preserved in the aperture. It will be appreciated that one or more dry-etch parameters of the first etch process and the second etch process can be selected as desired to ensure that the cross-sectional profile of the aperture either is or is not of the same type as that of the laser-machined feature 22.

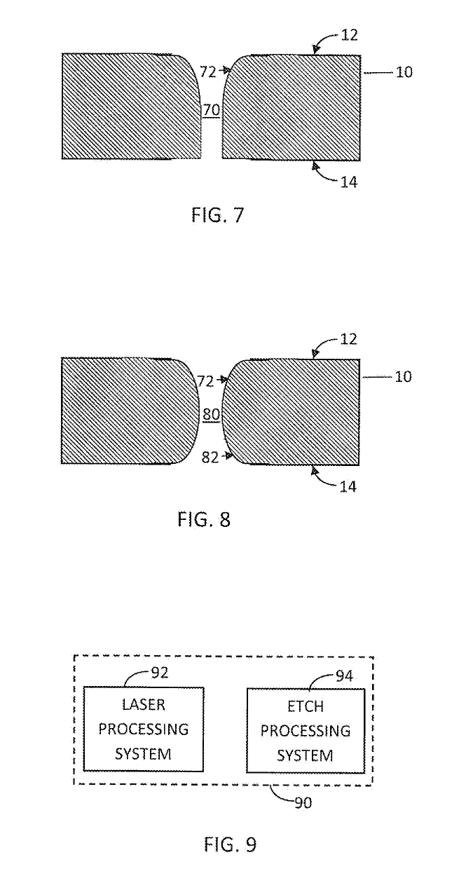

Examples of types of cross-sectional profiles include tapered (e.g., in which the aperture 30 has a substantially straight sidewall 32 and a taper of less than 100% as exemplarily shown in FIG. 3, or greater than 100%), vertical (e.g., in which an aperture 40 has a substantially straight sidewall 42 and at least substantially 100% taper as exemplarily shown in FIG. 4), single scalloped (e.g., in which an aperture 50 includes a sidewall 52 having a concave portion adjacent to the first side 12 as exemplarily shown in FIG. 5, or adjacent to the second side 14), double scalloped (e.g., in which an aperture 60 includes a sidewall 52 having a concave portion adjacent to the first side 12 and a sidewall 62 adjacent to the second side 14 as exemplarily shown in FIG. 6), fluted (e.g., in which an aperture 70 includes a sidewall 72 having a convex portion adjacent to the first side 12 as exemplarily shown in FIG. 7, or adjacent to the second side 14), hourglass (e.g., in which an aperture 80 includes a sidewall 72 having a convex portion adjacent to the first side 12 and a sidewall 82 having a convex portion adjacent to the second side 14 as exemplarily shown in FIG. 8), as well as combinations of these profiles (e.g., an aperture having a sidewall portion such as sidewall 52 adjacent to the first side 12 as shown in FIG. 5 and a sidewall portion such as sidewall 42 adjacent to the second side 14). It will be also appreciated that one or more dry-etch parameters of the first etch process and the second etch process can be selected as desired to ensure that the cross-sectional profile of the aperture either is or is not of the same type as that of the laser-machined feature 22.

In another example, one or more of the aforementioned dry-etch parameters of each of the first and second etch processes can be selected to produce an aperture having a taper that is greater than 50%. For example, the taper of the aperture can be greater than 60% and less than 100%. In another example, however, the taper of the aperture can be greater than 100%.

In another example, one or more of the aforementioned dry-etch parameters can be selected to produce an aperture having entrance and exit diameters that are larger than corresponding entrance and exit diameters d1 and d2 of the laser-machined feature 22. For example, one or both of the entrance and exit diameters of an aperture produced by the first and second etch processes can be less than about 25 μm larger than corresponding entrance and exit diameters d1 and d2 of the laser-machined feature 22. In one embodiment, one or both of the entrance and exit diameters of an aperture produced by the first and second etch processes can be at less than 20 μm larger than corresponding entrance and exit diameters d1 and d2 of the laser-machined feature 22. In another embodiment, one or both of the entrance and exit diameters of an aperture produced by the first and second etch processes can be at least 4 μm larger than corresponding entrance and exit diameters d1 and d2 of the laser-machined feature 22.

In another example, one or more of the aforementioned dry-etch parameters can be selected to produce an aperture having sidewalls that are smoother than sidewalls of the laser-machined feature 22.

FIG. 9 is a schematic view of one embodiment of an apparatus configured to form an aperture in a substrate.

Referring to FIG. 9, an apparatus such as apparatus 90 include a laser-processing system 92, and an etch processing system 94. Although not shown, the laser-processing system 92 can generally include a laser configured to produce a beam of laser light, optics defining an optical path, and a chuck configured to receive and secure the substrate 10.

The etch processing system 94 may include one or more etch chambers, one or more etchant introduction systems (e.g., an etchant gas showerhead disposed within the etch chamber and coupled to an etchant gas source outside the etch chamber), one or more carrier gas introduction systems configured to introduce a carrier gas into the etch chamber, a substrate support system (e.g., a chuck) configured to support the substrate during the first and second etch processes, and other components for monitoring and/or controlling a temperature, flow rate, composition, etc., of dry etchant and/or carrier gas introduced into the etch chamber, or the like or a combination thereof.

In one embodiment, the substrate 10 can be flipped, rotated, reoriented or otherwise moved as described above outside an etch chamber (e.g., a substrate handling robot or the the like). In another embodiment, the substrate 10 can be flipped, rotated, reoriented or otherwise moved as described above within the etch chamber. Accordingly, in such an embodiment, the substrate support system may be configured to flip, rotate, reorient or otherwise move a chuck supporting the substrate 10 in any manner suitable to flip, rotate, reorient or otherwise move the substrate 10 within the etch chamber. In such an embodiment, the first and second etch processes may be performed by introducing dry etchant from the same etchant introduction system. Alternatively in such an embodiment, the first and second etch processes may be performed by introducing dry etchant from different etchant introduction systems each of which are disposed within the etch chamber on the same side of the substrate 10 (e.g., above the substrate 10 or below the substrate 10).

In embodiments where at least a portion of the first etch process is performed simultaneously with at least a portion of the second etch process (e.g., such that the substrate 10 does not need to be flipped, rotated, reoriented or otherwise moved between the first and second etch processes), the substrate support system may be configured to support the substrate 10 (e.g., at a peripheral region thereof) such that dry etchant can flow into the laser-machined feature 22 from the first and second sides 12 and 14 of the substrate 10 (e.g., from a first etchant introduction system disposed above the first side 12 and from a second etchant introduction system disposed below the second side 14, respectively).

Having described various apparatuses and methods above, it will be appreciated that embodiments of the present invention may be implemented and practiced in many different forms. Generally, the etch rate of a dry etchant decreases with increasing distance from a dry etchant source (e.g., a showerhead). Thus by etching the laser-machined feature 22 by introducing etchant (e.g., a dry etchant) into the laser-machined feature 22 from the first and second sides 12 and 14 of substrate 10 (e.g., via the aforementioned first and second etch processes described above), the distance-dependent reduction in etch rate of the dry etchant can be minimized. Consequently, the first and second etch processes can form an aperture from the laser-machined feature 22 faster than a conventional etch process in which a dry etchant in introduced into the laser-machined feature 22 from only one side of the substrate 10. Further, the first and second etch processes can be used to remove debris deposited on the first side 12 and/or the second side 14 of the substrate 10 during the laser-drilling process. It will be appreciated that the apparatus and methods exemplarily described herein may be incorporated within a substrate processing system including, for example, spin-on coater station, a laser-drilling station, a spin-cleaner station, a dry-etch station, a dry-etch chamber, or the like or a combination thereof.

Having described various apparatuses and methods above, it will be appreciated that embodiments of the present invention may be implemented and practiced in many different forms. In one example embodiment, an improved method for forming an aperture in a substrate having a top side and a bottom side with a laser processing system having a laser can be provided in which the laser processing system is provided with an etch chamber having a dry etchant. The laser-machined feature can be formed with the laser and the laser-machined feature can be etched with the etchant from both the top side and the bottom side of the substrate, thereby forming the aperture. In this example embodiment, the etch chamber can allow the substrate to be flipped.

In another example embodiment, an improved system for forming an aperture in a substrate having a top side and a bottom side with a laser processing system having a laser can be provided, in which the etch chamber has a dry etchant and the etch chamber is operative to permit laser machining of the substrate and etching of the laser-machined substrate from the top side and the bottom side with the dry etchant. In this example embodiment, the etch chamber can allow the substrate to be flipped.

In yet another example embodiment, an improved process of forming an aperture in a substrate having a top side and a bottom side by a laser processing system having a laser and an etch chamber having a dry etchant can be provided, in which a laser-machined feature can be formed in the substrate with the laser and the laser-machined feature can be etched with a dry etchant (e.g., from the top and bottom sides of the substrate) to form the aperture. In this example embodiment, the etch chamber can allow the substrate to be flipped.

The foregoing is illustrative of embodiments of the invention and is not to be construed as limiting thereof. Although a few example embodiments of the invention have been described, those skilled in the art will readily appreciate that many modifications are possible in the example embodiments without materially departing from the novel teachings and advantages of the invention. Accordingly, all such modifications are intended to be included within the scope of the invention as defined in the claims. Therefore, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A method of forming an aperture within a substrate, the method comprising:
providing the substrate having a first side and a second side opposite the first side;
irradiating the substrate with a laser beam to form a laser-machined feature within the substrate, the laser-machined feature having a sidewall; and
etching the sidewall with an etchant to change at least one characteristic of the laser-machined feature, wherein the etching comprises introducing the etchant into the laser-machined feature from the first side and the second side of the substrate.

2. The method of claim 1, wherein the etchant includes a dry etchant.

3. The method of claim 2, wherein the dry etchant is one of a fluorocarbon, oxygen, chlorine, or boron tetrachloride compound.

4. The system of claim 3 wherein the dry etchant includes xenon difluoride.

5. The method of claim 1, wherein the etching comprises:
performing a first etch process including introducing the etchant into the laser-machined feature from the first side of the substrate; and
performing a second etch process including introducing the etchant into the laser-machined feature from the second side of the substrate.

6. The method of claim 5, wherein the etching comprises performing at least a portion of the first etch process and at least a portion of the second etch process simultaneously.

7. The method of claim 5, wherein the etching comprises performing at least a portion of the first etch process and performing at least a portion of the second etch process at different times.

8. The method of claim 5, wherein the etching comprises moving the substrate between the first etch process and the second etch process.

9. The method of claim 8, wherein moving the substrate comprises flipping the substrate.

10. The method of claim 1, wherein the at least one characteristic comprises a surface roughness of the sidewall.

11. The method of claim 1, wherein the at least one characteristic comprises a taper of the laser-machined feature.

12. The method of claim 1, wherein the at least one characteristic comprises a cross-sectional profile of the laser-machined feature

13. The method of claim 1, wherein the at least one characteristic comprises an aspect ratio of the laser-machined feature.

14. The method of claim 1, wherein the substrate is a semiconductor substrate.

15. A system for forming an aperture within a substrate having a first side and a second side, the system comprising:
a laser configured to irradiate the substrate with a laser beam to form a laser-machined feature within the substrate; and
an etch processing system having an etch chamber configured to receive the substrate, the etch processing system configured to introduce an etchant into the laser-machined feature from the first side and the second side to the substrate, the etchant configured to remove at least a portion substrate adjacent to the laser-machined feature.

16. The system of claim 15, wherein the etchant includes a dry etchant.

17. The system of claim 15, wherein the etch processing system is configured to:
perform a first etch process including introducing the etchant into the laser-machined feature from the first side of the substrate; and
perform a second etch process including introducing the etchant into the laser-machined feature from the second side of the substrate.

18. The system of claim 17, wherein the etch processing system is further configured to perform at least a portion of the first etch process and at least a portion of the second etch process simultaneously.

19. The system of claim 17, wherein the etch processing system is further configured to perform at least a portion of the first etch process and at least a portion of the second etch process at different times.

20. The system of claim 17, wherein the etch processing system is configured to flip the substrate within the etch chamber between the first etch process and the second etch process.
